(19) United States
(12) Patent Application Publication
(10) Pub. No.: US 2025/0370956 A1
(43) Pub. Date: Dec. 4, 2025

(54) METHOD, DEVICE, AND COMPUTER PROGRAM PRODUCT FOR GENERATING RETENTION STRATEGY

(71) Applicant: DELL PRODUCTS L.P., ROUND ROCK, TX (US)

(72) Inventors: Zijia Wang, London (GB); Zhen Jia, Shanghai (CN); Wenqing Peng, Shanghai (CN); Jinru Yan, Shanghai (CN)

(21) Appl. No.: 18/806,976

(22) Filed: Aug. 16, 2024

(30) Foreign Application Priority Data
Jun. 4, 2024 (CN) 202410713583.6

(51) Int. Cl. G06F 16/11

(52) U.S. Cl. CPC G06F 16/125

(57) ABSTRACT

A method includes determining, based on historical access data and a current data parameter, a root node representing a current state and at least one child node including an alternative strategy. The method further includes generating at least one extension node including an alternative strategy based on predictions of the historical access data and the at least one child node. The method further includes generating a first state vector by encoding tree-structured data including the root node, the child node, and the extension node. The method further includes selecting the alternative strategy corresponding to the child node or the extension node based on the first state vector to generate the retention strategy. Through this method, predicted future states can be integrated in a process of generating the retention strategy, which provides a more comprehensive perspective for decision-making, thereby improving the accuracy and effectiveness of the strategy.

### TECHNICAL FIELD

The present disclosure relates to the field of data management, and more specifically, to a method, device, and computer program product for generating a retention strategy.

### BACKGROUND

In the field of data protection, retention time management of backup data is an important aspect. In related technologies, a process of retention time management mainly relies on fixed and rule-based strategies. These strategies are usually pre-set and static, and they determine retention periods of data based on pre-determined schedules or simple business standards.

With the continuous growth of data volume and the increasing complexity of business requirements, a method of combining pre-set data retention strategies and manual intervention and decision-making is widely adopted. The method combines predefined rules with human judgment to adapt to data retention requirements in different situations. The method typically relies on the experience and judgment of information technology (IT) administrators, who need to flexibly adjust retention periods of data according to actual situations.

### SUMMARY OF THE INVENTION

Embodiments of the present disclosure propose a method, device, and computer program product for generating a retention strategy.

In a first aspect of the embodiments of the present disclosure, a method for generating a retention strategy is provided. The method includes determining, based on historical access data and a current data parameter, a root node representing a current state and at least one child node including an alternative strategy. The method further includes generating at least one extension node including an alternative strategy based on predictions of the historical access data and the at least one child node. The method further includes generating a first state vector by encoding tree-structured data including the root node, the at least one child node, and the at least one extension node. The method further includes selecting the alternative strategy corresponding to the at least one child node or the at least one extension node based on the first state vector to generate the retention strategy.

In a second aspect of the embodiments of the present disclosure, an electronic device is provided. The electronic device includes one or a plurality of processors; and a storage apparatus for storing one or a plurality of programs, wherein the one or a plurality of programs, when executed by the one or a plurality of processors, cause the one or the plurality of processors to implement a method for generating a retention strategy, and the method includes determining, based on historical access data and a current data parameter, a root node representing a current state and at least one child node including an alternative strategy. The method further includes generating at least one extension node including an alternative strategy based on predictions of the historical access data and the at least one child node. The method further includes generating a first state vector by encoding tree-structured data including the root node, the at least one child node, and the at least one extension node. The method further includes selecting the alternative strategy corresponding to the at least one child node or the at least one extension node based on the first state vector to generate the retention strategy.

In a third aspect of the present disclosure, a computer-readable storage medium having a computer program stored thereon is provided, the program, when executed by a processor, implements a method for generating a retention strategy, and the method includes determining, based on historical access data and a current data parameter, a root node representing a current state and at least one child node including an alternative strategy. The method further includes generating at least one extension node including an alternative strategy based on predictions of the historical access data and the at least one child node. The method further includes generating a first state vector by encoding tree-structured data including the root node, the at least one child node, and the at least one extension node. The method further includes selecting the alternative strategy corresponding to the at least one child node or the at least one extension node based on the first state vector to generate the retention strategy.

It should be understood that the content described in the Summary of the Invention part is neither intended to limit key or essential features of the embodiments of the present disclosure, nor intended to limit the scope of the present disclosure. Other features of the present disclosure will become readily understood from the following description.

### BRIEF DESCRIPTION OF THE DRAWINGS

The above and other features, advantages, and aspects of the embodiments of the present disclosure will become more apparent with reference to the accompanying drawings and the following detailed description. In the accompanying drawings, identical or similar reference numerals represent identical or similar elements, in which

FIG. 1 shows a schematic diagram of an example environment in which a plurality of embodiments of the present disclosure can be implemented;

FIG. 2 shows a flow chart of a method for generating a retention strategy according to some embodiments of the present disclosure;

FIG. 3 shows a schematic diagram of a process of training a reinforcement learning model according to some embodiments of the present disclosure;

FIG. 4 shows a flow chart of a process of selecting an optimal strategy by utilizing a reinforcement learning model according to some embodiments of the present disclosure;

FIG. 5 shows a schematic diagram of a process of Monte Carlo tree search (MCTS) in a tree neural network (TNN) according to some embodiments of the present disclosure;

FIG. 6 shows a schematic diagram of a process of generating a state vector by utilizing a graph neural network (GNN) according to some embodiments of the present disclosure; and

FIG. 7 is a block diagram of a device that can implement a plurality of embodiments of the present disclosure.

### DETAILED DESCRIPTION

The embodiments of the present disclosure will be described below in further detail with reference to the accompanying drawings. Although the accompanying drawings show some embodiments of the present disclosure, it should be understood that the present disclosure may be implemented in various forms, and should not be explained as being limited to the embodiments stated herein. Rather, these embodiments are provided for understanding the present disclosure more thoroughly and completely. It should be understood that the accompanying drawings and embodiments of the present disclosure are for illustrative purposes only, and are not intended to limit the scope of protection of the present disclosure.

In the description of the embodiments of the present disclosure, the term “include” and similar terms thereof should be understood as open-ended inclusion, that is, “including but not limited to.” The term “based on” should be understood as “based at least in part on.” The term “an embodiment” or “the embodiment” should be understood as “at least one embodiment.” The terms “first,” “second,” and the like may refer to different or identical objects. Other explicit and implicit definitions may also be included below.

In the field of data retention technologies, strategy-based systems were once a common method. The method relies on preset and static strategies to determine a retention period of data, and these strategies are usually based on fixed schedules or simple business logic. However, with the continuous growth of data volume, changes in business environment, and increasingly stringent regulatory compliance requirements, limitations of the strategy-based systems are gradually exposed. Due to the inability to dynamically adapt to these changes, these systems often lead to unnecessary data accumulation or premature data deletion, thereby wasting storage resources. At the same time, although manual management and decision-making methods are combined in certain situations, this method not only consumes a lot of manpower and time, but is also susceptible to human errors and subjectivity, thereby resulting in inconsistent and unpredictable data retention strategies.

In related technologies, general prediction models are also used to generate a data retention strategy. The method estimates future storage requirements or data correlation through a basic prediction algorithm, thereby providing a reference for formulation of a data retention strategy. However, due to the complexity and variability of the data environment, these simple prediction models often face challenges. They generally cannot accurately predict complex future scenarios involving a plurality of factors such as cost changes, regulatory changes, or technological advancements. In addition, predictions of these models are usually static and lack real-time adaptability to constantly changing business environments and regulatory requirements, and therefore, it is difficult to achieve the expected effect in practical applications.

In view of this, the embodiments of the present disclosure propose a solution for generating a retention strategy. The solution determines a root node representing a current state through a current data parameter, and determines a child node including an alternative retention strategy through historical access data. Then, prediction is performed according to the historical access data and the child node to generate an extension node including an alternative strategy. A state vector is generated by encoding tree-structured data including the root node, the child node, and the extension node, and finally, the alternative strategy is selected according to the state vector to generate the retention strategy. Through this method, predicted future states can be integrated in a process of generating the retention strategy, which provides a more comprehensive perspective for decision-making, thereby improving the accuracy and effectiveness of the retention strategy, and improving the utilization of storage resources. In addition, when the data environment changes, strategies can also be adjusted according to the changes to ensure the real-time adaptability of the generated retention strategy, thereby achieving dynamic and intelligent management of data retention time.

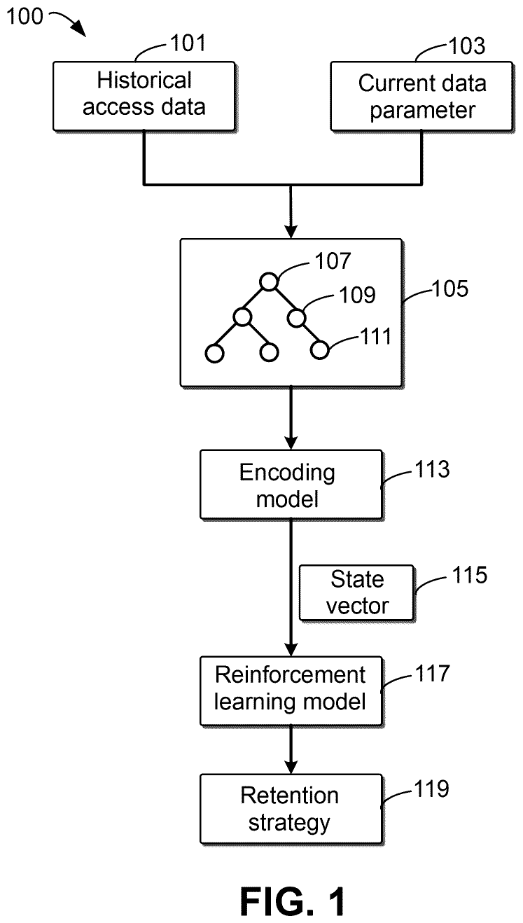

FIG. 1 shows a schematic diagram of an example environment 100 in which a plurality of embodiments of the present disclosure can be implemented. As shown in FIG. 1, the example environment 100 may include historical access data 101 and a current data parameter 103. The historical access data 101 may be records of user or system access to resources such as files, databases, websites, and applications during a certain period of time in the past, or may also be data such as user behaviors, system responses, and environmental variables. For example, the historical access data 101 may include access time, access user (or system identifier), type of resource accessed, access method (such as read, write, and delete), access result, and the like. The current data parameter 103 may be a data status or configuration of a system, an application, or a specific function at a certain moment. The current data parameter 103 may include various types of data and configuration items, such as a system configuration parameter, a database connection parameter, a user preference setting, and a business data status. The current data parameter 103 may be static, such as a predefined constant value in the system, or dynamic, such as a value that changes in real time according to the user behavior or system status.

In some embodiments, a root node 107 in tree-structured data 105 may be determined according to the current data parameter 103, and the tree-structured data 105 may be a hierarchical or nested data set. The tree-structured data 105 may include one root node 107 used for representing the current data state, and the root node 107 may have a plurality of child nodes 109. In the embodiments of the present disclosure, each child node 109 may include an alternative strategy, and the alternative strategy may be predefined. The predefined alternative strategy may be selected according to actual needs. For example, the alternative strategy may be deleting retained data every other day, or deleting retained data every other week. After determining the root node 107 and at least one child node 109, possible future situations may be predicted for the alternative strategy of each child node 109 and the pattern or trend of the historical access data 101, so as to make a future alternative strategy to generate an extension node 111. Each extension node 111 may include the predicted alternative strategy.

As shown in FIG. 1, in the example environment 100, an encoding model 113 may be utilized to encode the tree-structured data 105 and generate a state vector 115. The encoding model 113 may be a model used for capturing relationships and attributes between nodes in the tree-structured data 105, encoding the entire tree-structured data 105 into the state vector 115 that is easy to process, providing support for subsequent tasks, and improving the efficiency and accuracy of processing the tree-structured data 105. After the state vector 115 is generated, the state vector 115 is used as an input vector to a reinforcement learning model 117, and the trained reinforcement learning model 117 is utilized to select the alternative strategy in the child node 109 or extension node 111 to generate a retention strategy 119.

As can be seen from the above explanation, after generating the child node including the alternative retention strategy, the solution performs prediction according to the historical access data and the child node and generates the extension node including the alternative strategy. A state vector is generated by encoding tree-structured data including the root node, the child node, and the extension node, and finally, the alternative strategy is selected according to the state vector to generate the retention strategy. Through this method, in the process of generating the data retention strategy, a state vector that can accurately reflect the overall data structure is generated. This state vector can integrate predictions of future states, thereby providing a more comprehensive and in-depth perspective for a decision-making process. The method of formulating a forward-looking strategy not only enhances the accuracy and effectiveness of a retention strategy, but also significantly improves the utilization efficiency of storage resources. In addition, when the data environment changes, strategies can also be adjusted according to the changes to ensure the real-time adaptability of the generated retention strategy, thereby achieving dynamic and intelligent management of data retention time.

It should be understood that the architecture and functions in the example environment 100 are described only for example purposes without implying any limitation to the scope of the present disclosure. The embodiments of the present disclosure may also be applied to other environments having different structures and/or functions.

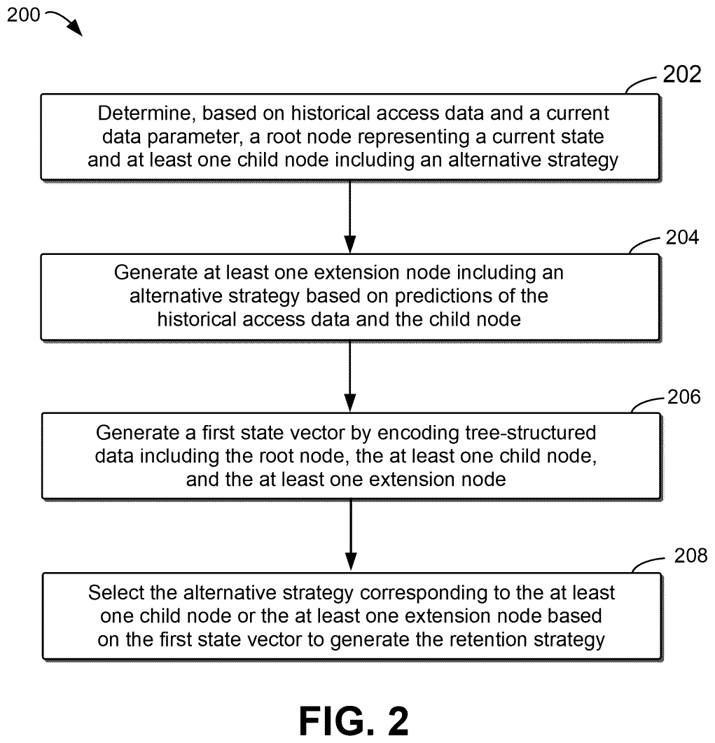

A process of the embodiment of the present disclosure will be described in detail below with reference to FIG. 2 to FIG. 6. For ease of understanding, the specific data mentioned in the following description are all illustrative and are not intended to limit the scope of protection of the present disclosure. It should be understood that the embodiments described below may also include additional actions not shown and/or may omit actions shown, and the scope of the present disclosure is not limited in this regard.

FIG. 2 shows a flow chart of a method 200 for generating a retention strategy according to some embodiments of the present disclosure. At a block 202, a root node representing a current state and at least one child node including an alternative strategy are determined based on historical access data and a current data parameter. For example, as shown in FIG. 1, the historical access data 101 may be records of user or system access to resources over a past time period. The historical access data 101 may include information such as access time, user identifier, resource type, access method, and access result, and provide a basis for understanding user behaviors, system performance, and resource usage. The current data parameter 103 may be a data status or configuration of a system, an application, or a specific function at a certain moment for determining the root node 107 representing the current state. The root node 107 represents the current data state, while child nodes 109 spread around the root node 107, and each child node 107 may include an alternative strategy for the data state.

At a block 204, at least one extension node including an alternative strategy is generated based on the predictions of the historical access data and the child node. For example, as shown in FIG. 1, the alternative strategies of the child nodes 109 may be according to different assumptions, conditions, or goals, and selecting each alternative strategy has a different advantage and risk. In the embodiment of the present disclosure, a prediction model may be utilized to collect and analyze the historical access data 101. By analyzing the pattern or trend in the historical access data 101, a potential impact of the alternative strategy of the child node 109 on a future situation may be predicted. The predicted information may include changes in user needs, fluctuations in system performance, changes in external environment, and the like. For each child node 109, according to the predicted future situation, a plurality of extension nodes 111 may be generated. The extension node 111 may be a grandchild node of the root node 107 or a great-grandchild node of the root node 107. The number of layers in the tree-structured data 105 may be selected according to actual needs.

In some embodiments, before the prediction model is utilized to generate the extension node 111, an environmental parameter in the prediction model may be set according to changes in the data environment. The setting of the environmental parameter may be based on storage capacity, storage speed, storage cost, central processing unit (CPU)/graph processing unit (GPU) computing power, changes in user demand, regulatory environment, and the like. Adjusting the prediction model according to actual needs can generate an alternative strategy with higher accuracy, thereby improving the accuracy and effectiveness of the retention strategy 119.

In some embodiments, the child node 109 and the extension node 111 may indicate data volume, data type, alternative strategy, storage parameter, and preset condition. The data volume represents the amount of data, the data type represents the nature of the data, the alternative strategy may include detailed information on a retention strategy applicable to the data, the storage parameter may include current and estimated costs related to data storage, and the preset condition may include relevant legal and regulatory obligations that affect the retention decision.

At a block 206, a first state vector is generated by encoding the tree-structured data including the root node, at least one child node, and at least one extension node. For example, as shown in FIG. 1, the encoding model 113 may be utilized to encode the tree-structured data 105 and generate the state vector 115. In some embodiments, the encoding model 113 may adopt a GNN model, and adopting the GNN model can accurately capture relationships and attributes between nodes of the tree-structured data 105, and encode the entire tree-structured data 105 into the state vector 115 that is easy to process, thereby providing support for subsequent tasks and improving the efficiency and accuracy of processing the tree-structured data 105.

At a block 208, the alternative strategy corresponding to the at least one child node or the at least one extension is selected based on the first state vector to generate the retention strategy. For example, as shown in FIG. 1, the first state vector may be the state vector 115. After the state vector 115 is generated, the state vector 115 is used as an input vector to the reinforcement learning model 117, and the trained reinforcement learning model 117 is utilized to select the optimal alternative strategy in the child node 109 or extension node 111 to generate the retention strategy 119.

Through this method, predicted future states can be integrated in a process of generating the retention strategy, which provides a more comprehensive perspective for decision-making, thereby improving the accuracy and effectiveness of the retention strategy, and improving the utilization of storage resources. In addition, when the data environment changes, strategies can also be adjusted according to the changes to ensure the real-time adaptability of the generated retention strategy, thereby achieving dynamic and intelligent management of data retention time.

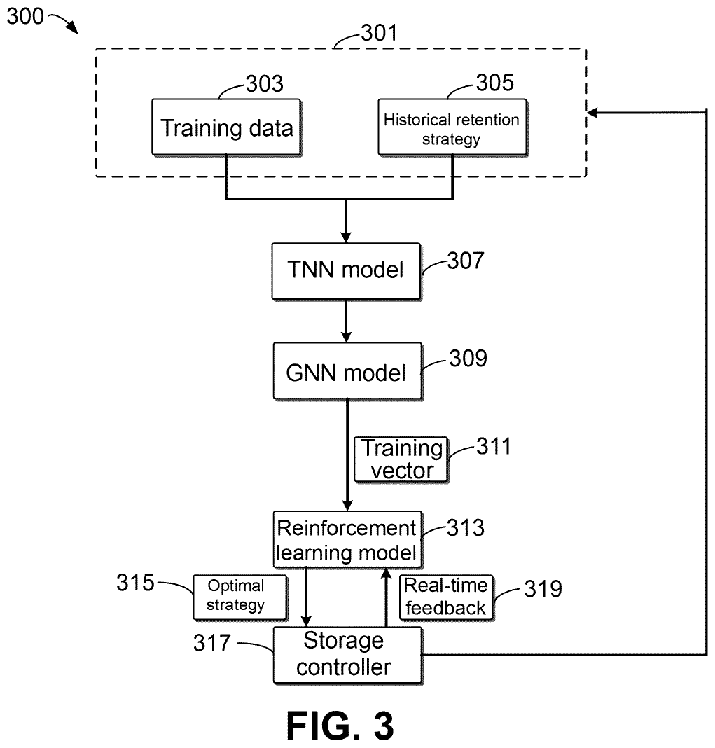

The process of generating a retention strategy will be specifically described below with reference to FIG. 3 to FIG. 7. In the embodiment of the present disclosure, explanations are provided in the order of training a reinforcement learning model, selecting an optimal strategy by utilizing the reinforcement learning model, updating tree-structured data, and generating a state vector. The specific data referred to in the following description are illustrative and are not intended to limit the protection scope of the present disclosure. It should be understood that the embodiments described below may also include additional actions not shown and/or may omit actions shown, and the scope of the present disclosure is not limited in this regard.

FIG. 3 shows a schematic diagram of a process 300 of training a reinforcement learning model according to some embodiments of the present disclosure. As shown in FIG. 3, a reinforcement learning model 313 may be the untrained reinforcement learning model 117 in FIG. 1. After the reinforcement learning model 313 is trained, the reinforcement learning model 117 may be obtained. An experience pool 301 used for training the reinforcement learning model 313 may include training data 303 and a historical retention strategy 305. The training data 303 may be historical access data, that is, the training data 303 may be records of user or system access to resources in a past time period. The historical access data 101 may include information such as access time, user identifier, resource type, access method, and access result, thereby providing a basis for understanding user behaviors, system performance, and resource usage. The historical retention strategy 305 may be a retention strategy that has been used on data in the past time period.

In some embodiments, a TNN model 307 may be utilized to generate, based on the experience pool, the tree-structured data for training. The process of generating the tree-structured data for training includes utilizing the TNN model 307 to generate a training root node, a training child node, and a training extension node based on the training data 303. The generation method of the training root node, the training child node, and the training extension node is consistent with the generation method of the root node, the child node, and the extension node in FIG. 2, and will not be elaborated here.

In some embodiments, after the tree-structured data for training is generated, a GNN model 309 may be used to encode the tree-structured data for training, and capture the relationships and attributes between nodes of the tree-structured data 105, so as to generate a training vector 311. The training vector 311 may be represented as:

$$v\_i = f ( W * concat ( v\_i , agg ( children ( v\_i ) ) ) + b ) \qquad ( 1 )$$

wherein v_i represents the vector representation of a node i, W represents the weight, b represents the bias, concat represents a function that connects the current state of the node with aggregated child information, agg represents an aggregation function of combining data of the child node and the extension node, and f represents a nonlinear activation function.

As shown in FIG. 3, after the training vector 311 is generated, the training vector 311 may be used as an input to the reinforcement learning model 313, and the training vector 311 contains state information of the current environment. The reinforcement learning model 313 may adopt a Deep Q-Network (DQN) model. After the training vector 311 is received, the reinforcement learning model 313 selects an optimal strategy 315 based on the training vector 311, and then a storage controller 317 executes the optimal strategy 315. The storage controller 317 may be a hardware component that controls and manages storage devices, such as hard drives, solid-state drives, and flash drives. The storage controller 317 provides real-time feedback on the changes in the data retention environment after executing the optimal strategy 315 to the reinforcement learning model 313 for training, and puts the information about the changes in the data retention environment and the selected optimal strategy 315 into the experience pool 301 as a database for training the reinforcement learning model 313. By continuously selecting the optimal strategy 315, the objective of training the reinforcement learning model 313 can be achieved.

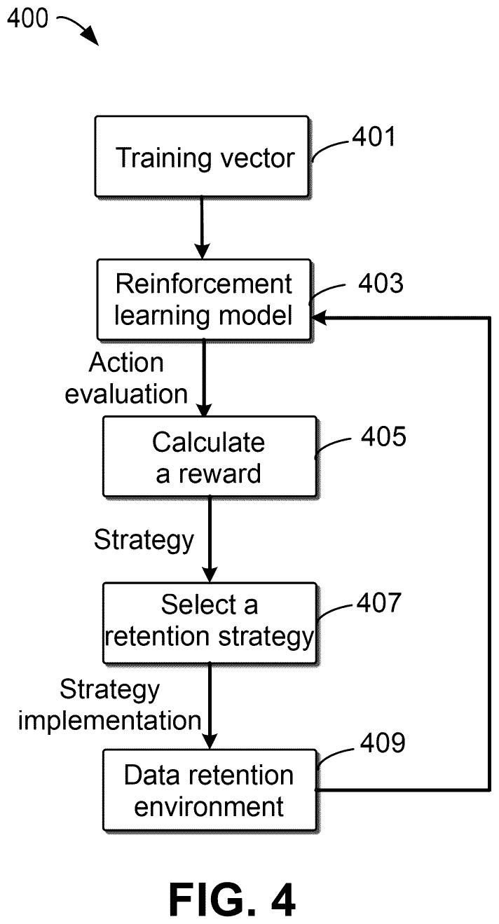

FIG. 4 is a schematic diagram of a process 400 of selecting an optimal strategy by utilizing a reinforcement learning model according to some embodiments of the present disclosure. As shown in FIG. 4, a GNN model is utilized to encode tree-structured data, and a training vector 401 may be obtained. The training vector 401 is used as an input for a reinforcement learning model 403, and the reinforcement learning model 403 may adopt a Deep Q-Network (DQN) model. The DQN model is a core decision-making component used for generating a retention strategy. The DQN model integrates encoding information from the GNN model and utilizes the training vector 401 that can reflect a potential future scenario and decision-making path to learn and determine an optimal retention strategy.

At a block 405, the DON model adopts a reward learning framework to evaluate the quality of an action taken in each state. The DON model includes a plurality of neural network layers, each layer integrating the information encoded by the GNN model, that is, the training vector 401. The training vector 401 is combined with other relevant data, such as a current storage capacity cost parameter. The learning process of the DQN model is driven by a reward mechanism, and the reward mechanism may evaluate the results of actions in terms of cost efficiency, data availability, and compliance. By using the rewards, the expected return on actions is estimated to guide the selection of the most beneficial actions.

At a block 407, the DON model selects the optimal retention strategy according to the calculated reward. A reward value calculated by the DON model may be referred to as a Q-value reward. After calculating the Q-value for each data instance according to the encoded tree-structured data, the DON module selects the optimal retention strategy and outputs actions such as retention, deletion, and archiving according to the Q-values. Then, the selected retention strategy is executed in the data retention environment 409. Finally, the DQN model is trained according to the execution result, so that the DON model continuously improves the retention strategy to adapt to constantly changing conditions and goals, which minimizes storage costs while improving the adaptability to environmental changes. The optimization algorithm may be expressed as:

$$Q ( s , a ) = Q ( s , a ) + \backslash alpha [ r + ∖ gamma \backslash max\_ \{ {a}^{′} \} Q \{ {s}^{′} , {a}^{′} ) - Q ( s , a ) ] \qquad ( 2 )$$

wherein Q(s,a) represents a reward value for taking an action a in a state s, a represents the learning rate, r represents a reward obtained after taking an action in the state s, γ represents a discount coefficient for a future reward, s′ represents a next state after taking the action a, and a′ represents an action that may be taken in the next state s′.

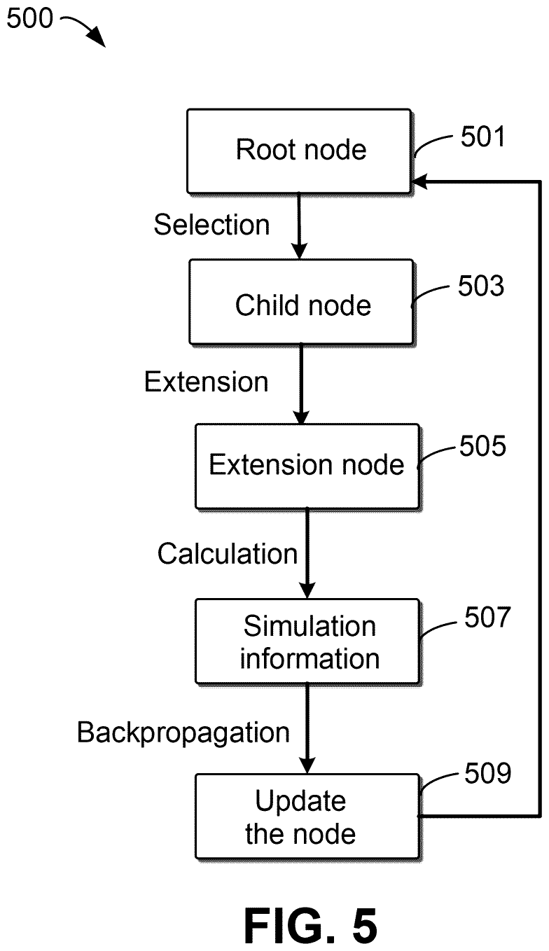

FIG. 5 shows a schematic diagram of a process 500 of an MCTS in a TNN according to some embodiments of the present disclosure. As shown in FIG. 5, after a root node 501 and a child node 503 are determined, any child node 503 may be selected for prediction to generate a corresponding extension node 505. At a block 507, the child node and the extension node are simulated to generate simulation information. The extension node 505 is generated according to predictions of the child node 503 and historical access data, and the accuracy of the extension node 505 and the availability of an alternative strategy cannot be guaranteed; therefore, before encoding the tree-structured data, the estimation of the future scenario may be simulated by simulating the execution of the alternative strategies in the child node 503 and the extension node 505, thereby evaluating the feasibility of different alternative strategies.

At a block 509, the tree-structured data is updated according to the simulation information. For each child node 504 and the extension node 505, after the simulation information 507 is generated, the tree-structured data is updated according to the simulation information 507 to achieve the objective of node correction. In some embodiments, the update process may be determining aggregated simulation information of direct successor nodes for each child node 503 and the extension node 505, and updating the child node 503 and the extension node 505 according to the aggregated simulation information.

In some embodiments, the tree-structured data including the root node 501, the updated child node 503, and the updated extension node 505 may be encoded to generate a state vector, and the generated state vector may be input into a reinforcement learning model to generate a retention strategy. By taking a preposed measure of simulating nodes before encoding, the performance of an alternative strategy in an actual operation can be estimated to generate a detailed simulation result to correct the tree-structured data. The corrected nodes can indicate potential risks and compliance in future scenarios, and the corrected actions can ensure the accuracy and effectiveness of the tree-structured data, thereby more accurately predicting the future scenarios and improving the scientificity and effectiveness of the decision-making process.

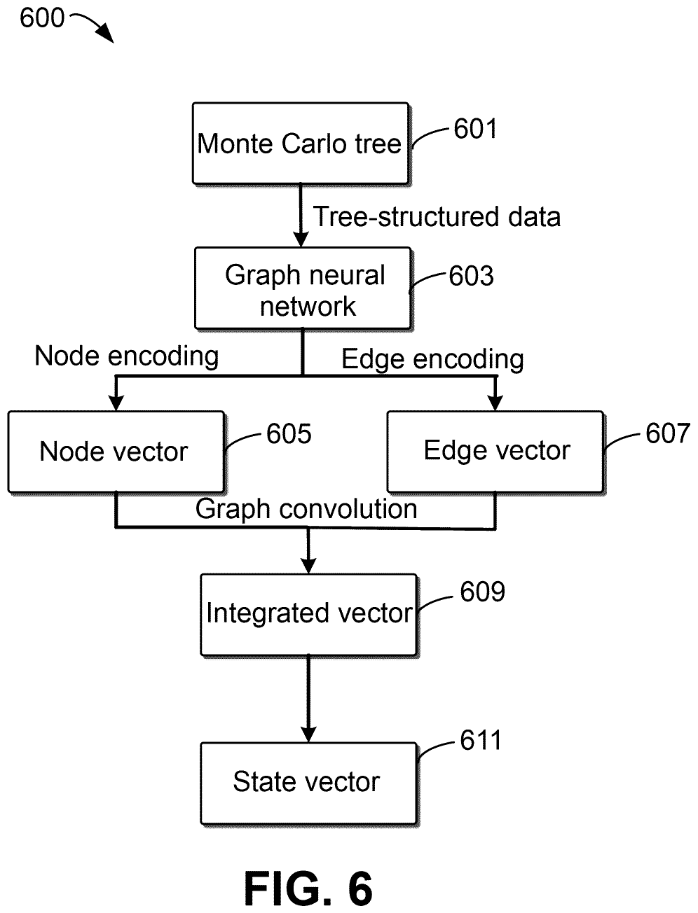

FIG. 6 shows a schematic diagram of a process 600 of generating a state vector by utilizing a GNN according to some embodiments of the present disclosure. As shown in FIG. 6, a task of a GNN model 603 is encoding a Monte Carlo tree 601 generated by a TNN model during an MCTS process. In the embodiment of the present disclosure, the GNN model 603 is directly connected to the TNN module and receives the Monte Carlo tree 601 dynamically generated by the TNN module as its input. The GNN module 603 performs encoding by capturing dependencies between different potential future scenarios and decisions represented in the Monte Carlo tree 601.

In some embodiments, the encoding process of the GNN model 603 may include encoding each node in the tree-structured data to generate a node vector 605. Each node in the tree-structured data represents a potential decision or state, and the GNN model 603 encodes the node into a high-dimensional space. The encoding process of the GNN model 603 may further include encoding edges between interconnected nodes in the tree-structured data to generate an edge vector 607. The edge vector 607 represents a transition from one node to another, that is, a transition from one state to another state. Encoding the edge vector 607 can implement capturing of the property of the decision or action that is taken. By integrating the node vector 605 and the edge vector 607, a state vector 611 may be obtained. The GNN model 603 applies graph convolution operations to the node vector 605 and the edge vector 607, and in this way, node information can be integrated with a global tree structure to enhance the decision-making context. In the embodiment of the present disclosure, the GNN model 603 generates the node vector 605 according to a feature of each node itself and aggregated information from its neighbors, and the node vector 605 may be generated using the following formula:

$$h\_i \hat{} \{ l + 1 \} = \backslash σ \backslash left ( W \hat{} \{ ( 1 ) \} \backslash cdot \backslash text \{ AGGREGATE \} \backslash left ( \backslash \{ h\_j \hat{} \{ ( 1 ) \} : j \backslash in \backslash text \{ Neighbors \} ( i ) \backslash \vert \backslash right ) + b \hat{} \{ ( 1 ) \} \vert \backslash right \qquad ( 3 )$$

wherein h_i\hat{ }{(1)} represents a feature vector of a node i in the 1-th layer, W\hat{ }{(1)} represents a weight of the 1-th layer, b\hat{ }{(1)} represents a bias of the 1-th layer, AGGREGATE represents features of the aggregated neighboring nodes, σ represents a non-linear activation function, and Neighbors represents neighbor nodes.

In some embodiments, the state vector 611 output by the GNN model 603 may be used as the input to the reinforcement learning model, and the reinforcement learning model is utilized to select the retention strategy. When using reinforcement learning models alone, it is difficult to represent the complex states of the data retention environment, and the states that can be represented are relatively limited. It is also difficult to effectively capture the relationships and dependencies between different data entities and retention decisions. In the embodiment of the present disclosure, the GNN model 603 is utilized to encode the Monte Carlo tree, which can represent complex decision paths and state interdependencies through the state vector 611, thereby improving the accuracy and granularity of understanding the data retention environment.

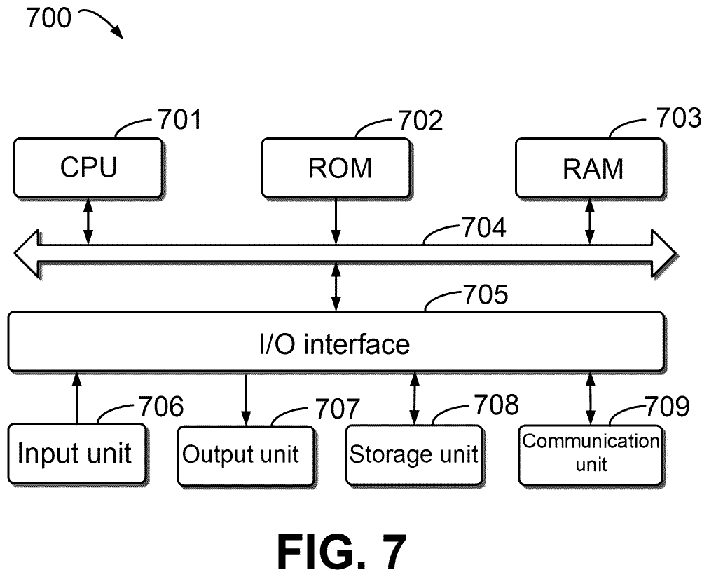

FIG. 7 shows a schematic block diagram of an example device 700 which can be used to implement embodiments of the present disclosure. As shown in the figure, the device 700 includes a computing unit 701 that can perform various appropriate actions and processing according to computer program instructions stored in a read-only memory (ROM) 702 or computer program instructions loaded from a storage unit 708 to a random access memory (RAM) 703. Various programs and data required for the operation of the device 700 may also be stored in the RAM 703. The computing unit 701, the ROM 702, and the RAM 703 are connected to each other via a bus 704. An Input/Output (I/O) interface 705 is also connected to the bus 704.

Multiple components in the device 700 are connected to the I/O interface 705, including: an input unit 706, such as a keyboard and a mouse; an output unit 707, such as various types of displays and speakers; the storage unit 708, such as a magnetic disk and an optical disc; and a communication unit 709, such as a network card, a modem, and a wireless communication transceiver. The communication unit 709 allows the device 700 to exchange information/data with other devices via a computer network, such as the Internet, and/or various telecommunication networks.

The computing unit 701 may be various general-purpose and/or special-purpose processing components with processing and computing powers. Some examples of the computing unit 701 include, but are not limited to, central processing units (CPUs), graphics processing units (GPUs), various specialized artificial intelligence (AI) computing chips, various computing units for running machine learning model algorithms, digital signal processors (DSPs), and any appropriate processors, controllers, microcontrollers, etc. The computing unit 701 performs various methods and processes described above, such as the method 200. For example, in some embodiments, the method 200 may be implemented as a computer software program that is tangibly included in a machine readable medium, such as the storage unit 708. In some embodiments, part or all of the computer program may be loaded and/or installed onto the device 700 via the ROM 702 and/or the communication unit 709. When the computer program is loaded to the RAM 703 and executed by the computing unit 701, one or more steps of the method 200 described above may be performed. Alternatively, in other embodiments, the computing unit 701 may be configured to implement the method 200 in any other suitable manners (such as by means of firmware).

The functions described hereinabove may be executed at least in part by one or more hardware logic components. For example, without limitation, example types of available hardware logic components include: a Field Programmable Gate Array (FPGA), an Application Specific Integrated Circuit (ASIC), an Application Specific Standard Product (ASSP), a System on Chip (SOC), a Load Programmable Logic Device (CPLD), and the like.

Program codes for implementing the method of the present disclosure may be written by using one programming language or any combination of multiple programming languages. The program code may be provided to a processor or controller of a general purpose computer, a special purpose computer, or another programmable data processing apparatus, such that the program code, when executed by the processor or controller, implements the functions/operations specified in the flow charts and/or block diagrams. The program code may be executed completely on a machine, executed partially on a machine, executed partially on a machine and partially on a remote machine as a stand-alone software package, or executed completely on a remote machine or server.

In the context of the present disclosure, a machine-readable medium may be a tangible medium that may include or store a program for use by an instruction execution system, apparatus, or device or in connection with the instruction execution system, apparatus, or device. The machine-readable medium may be a machine-readable signal medium or a machine-readable storage medium. The machine-readable medium may include, but is not limited to, an electronic, magnetic, optical, electromagnetic, infrared, or semiconductor system, apparatus, or device, or any suitable combination of the above content. More specific examples of the machine-readable storage medium may include one or more wire-based electrical connections, a portable computer diskette, a hard disk, a random access memory (RAM), a read-only memory (ROM), an erasable programmable read-only memory (EPROM or flash memory), an optical fiber, a portable compact disc read-only memory (CD-ROM), an optical storage device, a magnetic storage device, or any suitable combinations thereof. Additionally, although operations are depicted in a particular order, this should be understood that such operations are required to be performed in the particular order shown or in a sequential order, or that all illustrated operations should be performed to achieve desirable results. Under certain environments, multitasking and parallel processing may be advantageous. Likewise, although the above discussion contains several specific implementation details, these should not be construed as limitations to the scope of the present disclosure. Certain features that are described in the context of separate embodiments may also be implemented in combination in a single implementation. Conversely, various features that are described in the context of a single implementation may also be implemented in a plurality of implementations separately or in any suitable sub-combination.

Although the present subject matter has been described using a language specific to structural features and/or method logical actions, it should be understood that the subject matter defined in the appended claims is not necessarily limited to the particular features or actions described above. Rather, the specific features and actions described above are merely example forms of implementing the claims.

1. A method for generating a retention strategy, comprising:
determining, based on historical access data and a current data parameter, a root node representing a current state and at least one child node comprising an alternative strategy;
generating at least one extension node comprising an alternative strategy based on predictions of the historical access data and the at least one child node;
generating a first state vector by encoding tree-structured data comprising the root node, the at least one child node, and the at least one extension node; and
selecting the alternative strategy corresponding to the at least one child node or the at least one extension node based on the first state vector to generate the retention strategy.

2. The method according to claim 1, wherein generating at least one extension node comprising an alternative strategy comprises:
generating at least one grandchild node comprising an alternative strategy based on the predictions of the historical access data and the child node.

3. The method according to claim 1, further comprising:
determining aggregated simulation information of a direct successor node for each child node and the extension node;
updating the child node and the extension node based on the aggregated simulation information;
generating a second state vector by encoding tree-structured data comprising the root node, the updated child node, and the updated extension node; and
selecting, based on the second state vector, the alternative strategy corresponding to the updated child node or the updated extension node to generate a second retention strategy.

4. The method according to claim 3, wherein determining aggregated simulation information of a direct successor node comprises:
simulating alternative strategies corresponding to each child node and the extension node to generate simulation information; and
determining, based on the simulation information, the aggregated simulation information of the direct successor node.

5. The method according to claim 1, wherein generating at least one extension node comprising an alternative strategy comprises:
determining an environmental parameter of a prediction model based on a prediction environment; and
generating the at least one extension node comprising an alternative strategy based on predictions of the historical access data and the child node by the prediction model.

6. The method according to claim 1, wherein generating a first state vector comprises:
generating a node vector by encoding each node in the tree-structured data using a graph neural network;
generating an edge vector by encoding an edge between interconnected nodes in the tree-structured data using the graph neural network; and
integrating the node vector and the edge vector to generate the first state vector.

7. The method according to claim 1, further comprising:
determining, based on training data and the current data parameter, a training root node representing the current state and at least one training child node comprising an alternative strategy;
generating at least one training extension node comprising an alternative strategy based on predictions of the training data and the at least one training child node;
generating a training vector by encoding tree-structured data comprising the training root node, the at least one training child node, and the at least one training extension node; and
selecting, by a reinforcement learning model based on the training vector, the alternative strategy corresponding to the at least one training child node or the at least one training extension node to generate a third retention strategy.

8. The method according to claim 7, wherein generating a third retention strategy comprises:
calculating a reward value of the corresponding alternative strategy for each training child node and each training extension node; and
generating the third retention strategy based on the reward value.

9. The method according to claim 8, further comprising:
executing the third retention strategy to generate feedback information in a data retention environment; and
training the reinforcement learning model based on the feedback information and a historical retention strategy in the data retention environment.

10. The method according to claim 1, wherein selecting the alternative strategy corresponding to the child node or the extension node to generate the retention strategy comprises:
selecting, by a trained reinforcement learning model based on the first state vector, the alternative strategy corresponding to the child node or the extension node to generate the retention strategy.

11. The method according to claim 1, wherein the child node and/or the extension node indicates data volume, data type, alternative strategy, storage parameter, and preset condition.

12. An electronic device, comprising:
at least one processor; and
a memory coupled to the at least one processor and having instructions stored thereon, wherein the instructions, when executed by the at least one processor, cause the electronic device to perform following operations:
determining, based on historical access data and a current data parameter, a root node representing a current state and at least one child node comprising an alternative strategy;
generating at least one extension node comprising an alternative strategy based on predictions of the historical access data and the at least one child node;
generating a first state vector by encoding tree-structured data comprising the root node, the at least one child node, and the at least one extension node; and
selecting the alternative strategy corresponding to the at least one child node or the at least one extension node based on the first state vector to generate a retention strategy.

13. The device according to claim 12, wherein generating at least one extension node comprising an alternative strategy comprises:
generating at least one grandchild node comprising an alternative strategy based on the predictions of the historical access data and the child node.

14. The device according to claim 13, wherein the operations further comprise:
determining aggregated simulation information of a direct successor node for each child node and the extension node;
updating the child node and the extension node based on the aggregated simulation information;
generating a second state vector by encoding tree-structured data comprising the root node, the updated child node, and the updated extension node; and
selecting, based on the second state vector, the alternative strategy corresponding to the updated child node or the updated extension node to generate a second retention strategy.

15. The device according to claim 14, wherein determining aggregated simulation information of a direct successor node comprises:
simulating alternative strategies corresponding to each child node and the extension node to generate simulation information; and
determining, based on the simulation information, the aggregated simulation information of the direct successor node.

16. The device according to claim 12, wherein generating at least one extension node comprising an alternative strategy comprises:
determining an environmental parameter of a prediction model based on a prediction environment; and
generating the at least one extension node comprising an alternative strategy based on predictions of the historical access data and the child node by the prediction model.

17. The device according to claim 12, wherein generating a first state vector comprises:
generating a node vector by encoding each node in the tree-structured data using a graph neural network;
generating an edge vector by encoding an edge between interconnected nodes in the tree-structured data using the graph neural network; and
integrating the node vector and the edge vector to generate the first state vector.

18. The device according to claim 12, wherein the operations further comprise:
determining, based on training data and the current data parameter, a training root node representing the current state and at least one training child node comprising an alternative strategy;
generating at least one training extension node comprising an alternative strategy based on predictions of the training data and the at least one training child node;
generating a training vector by encoding tree-structured data comprising the training root node, the at least one training child node, and the at least one training extension node; and
selecting, by a reinforcement learning model based on the training vector, the alternative strategy corresponding to the at least one training child node or the at least one training extension node to generate a third retention strategy.

19. The device according to claim 18, wherein generating a third retention strategy comprises:
calculating a reward value of the corresponding alternative strategy for each training child node and each training extension node; and
generating the third retention strategy based on the reward value.

20. A computer program product, the computer program product being tangibly stored on a non-volatile computer-readable medium and comprising machine-executable instructions, wherein the machine-executable instructions, when executed by a machine, cause the machine to perform following operations:
determining, based on historical access data and a current data parameter, a root node representing a current state and at least one child node comprising an alternative strategy;
generating at least one extension node comprising an alternative strategy based on predictions of the historical access data and the at least one child node;
generating a first state vector by encoding tree-structured data comprising the root node, the at least one child node, and the at least one extension node; and
selecting the alternative strategy corresponding to the at least one child node or the at least one extension node based on the first state vector to generate a retention strategy.
